(19) United States
(12) Patent Application Publication
(10) Pub. No.: US 2005/0125742 A1
(43) Pub. Date: Jun. 9, 2005

(54) Non-overlapping graphical user interface workspace

(75) Inventors: D. Kirk Grotjohn, Cary, NC (US); Thomas R. Haynes, Apex, NC (US); Mohamad R. Salahshoor, Raleigh, NC (US); Lucinio Santos-Gomez, Durham, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/731,304

(22) Filed: Dec. 9, 2003

(51) Int. Cl. G06F 3/00

(52) U.S. Cl. 715/799; 715/764; 715/790; 715/794; 715/798

(57) ABSTRACT

A user interface mechanism that introduces a novel concept referred to as a “non-overlapping workspace”. A system user can switch between the traditional overlapping workspace and the novel non-overlapping workspace, depending upon how they wish to move and manage objects in the workspace. In the non-overlapping mode, as the user moves a selected object to relocate it within the work area, as its border touches another object, the selected object pushes the other object (rather than cover it). In an alternative embodiment, when the system is in the non-overlapping mode, objects on the desktop have “sticky” borders, that is, as the border of a selected object comes into contact with the border of another object, the two objects are coupled to each other as though they were glued together, forming an “object unit”.

### BACKGROUND OF THE INVENTION

1. Field of the Invention

This invention relates to personal computer systems and, more particularly, to a method, system, and computer program product for improving a graphical user interface (GUI) on a personal computer system, and the use thereof.

2. Description of the Related Art

In recent years, virtually all personal computers and workstations have adopted a graphical user interface (GUI) environment, which allows a user to manage and execute applications using a “point and click” method on objects shown on the computer display. The main GUI background is commonly referred to as the “desktop” or workspace, and “objects” are typically displayed on the desktop. These objects may include graphic icons, which represent a software application or function, and windows, which divide the viewable portion of the desktop into different areas (“sub-desktops”) in which details pertaining to a particular application or operation are displayed.

One of the benefits of GUI's is the ability that they provide to operate and view multiple objects in the desktop area. Frequently a user will have three or four objects displayed on the GUI, leaving them easily accessible to the user when desired.

In the prior art multiple-object model, each object can be moved independently into different locations on the desktop. The view displayed to the user is essentially “three-dimensional”, that is, the view in the work area of the GUI is perceived as a series of layers, with the selected object being in the nearest plane or layer relative to the user and the remaining objects occupying layers or planes “beneath” (i.e., deeper) in the work area. Just like a physical desktop of a desk, when an object is selected and is moved onto the space occupied by another object, the selected object overlaps (covers) the other object, thereby obstructing the view of some or all of the object(s) underneath.

“Tiling” is a method conceived to help organize a desktop that contains multiple open windows while still allowing the user to continue to view the contents of each open window. When windows are tiled, they are sized according to the number of windows open (e.g., if there are 4 windows open, each window is sized to take up ¼ of the GUI work area). This has the drawback of changing the size of the window, which may have been individually sized by the user for optimal viewing. In addition, tiling open windows in this manner completely covers the desktop underneath, requiring the closing or minimizing of at least one of the windows if access to the desktop is needed. Finally, the windows will still overlap each other; movement of a selected one of the tiled windows over another of the tiled windows causes the selected window to come to overlap the tiled windows in the work area.

Probably the most often-used method of rearranging objects within a GUI is to simply manually move the objects to the location desired. This allows the user to place the objects in desired locations on the screen, and is accomplished, in the case of window objects, for example, by positioning the cursor on the title bar of the window, holding down the right mouse-button, and moving the mouse (and thus the window) to a desired location within the GUI work area. As noted above, however, when a selected window is moved into the space occupied by another window, the selected window overlaps other windows and blocks the view of the contents of the underlying windows, which is an undesirable situation in many instances.

Accordingly, it would be desirable to have a method and system that allows a user to move a selected object manually around a GUI screen without overlapping other objects occupying the space to which the selected window is being moved.

### SUMMARY OF THE INVENTION

The present invention is a user interface mechanism that introduces a novel concept referred to as a non-overlapping workspace. In a preferred embodiment, a system user can switch between the traditional overlapping workspace and the novel non-overlapping workspace, depending upon how they wish to move and manage objects in the workspace. In the non-overlapping mode, as the user moves a selected object to relocate it within the work area and its border touches another object, the selected object pushes the other object (rather than overlap it) since the two objects are in the same virtual plane.

In an alternative embodiment, when the system is in the non-overlapping mode, objects on the desktop are configured to have “sticky” borders, that is, as the border of a selected object comes into contact with the border of another object, the two objects adhere to each other as though they were glued together. This creates what is referred to herein as an “object unit” (two or more objects adhering to each other as a group), such that the two adhered objects now move in unison as a single unit. As the object unit is further moved, it may contact and adhere to additional objects as their borders collide, thus increasing the size of the object unit.

### BRIEF DESCRIPTION OF THE DRAWINGS

FIG. 1 shows a typical desktop D, displayed within a GUI 100;

FIG. 2 (prior art) illustrates how wherever window A and window B occupy the same space on the desktop, window A blocks the user's view of that portion of window B occupied by window A;

FIG. 3 illustrates when a user moves window A to the right, at some point the right border of window A will touch the left border of window B;

FIG. 4 illustrates what occurs when the user moves window A back to the left from the position to which it was pushed in FIG. 3;

FIG. 5 illustrates the selection of the “sticky object” mode of the present invention;

FIG. 6 illustrates what occurs when an object unit touches another window (or object) on the same desktop, and the desktop is in the sticky object mode, that window is “added” to the object unit;

FIG. 7 illustrates what occurs when the newly-formed object unit is moved upward, all three windows, including newly-added window C, move upward as a single group, i.e., as a new object unit comprising all three windows;

FIG. 8 illustrates an example of how the management option of the present invention could be implemented; and

FIG. 9 illustrates an example of the logical steps of the present invention.

### DETAILED DESCRIPTION OF THE PREFERRED EMBODIMENTS

To better understand the present invention, it is helpful to observe the operation of the prior art. All of the examples below illustrate the present invention and the prior art in an environment wherein the objects displayed on the desktop are window objects. However, it is understood that the present invention is not limited to window objects and can function with any objects, including desktop icons; graphical objects in modeling tools, and the like.

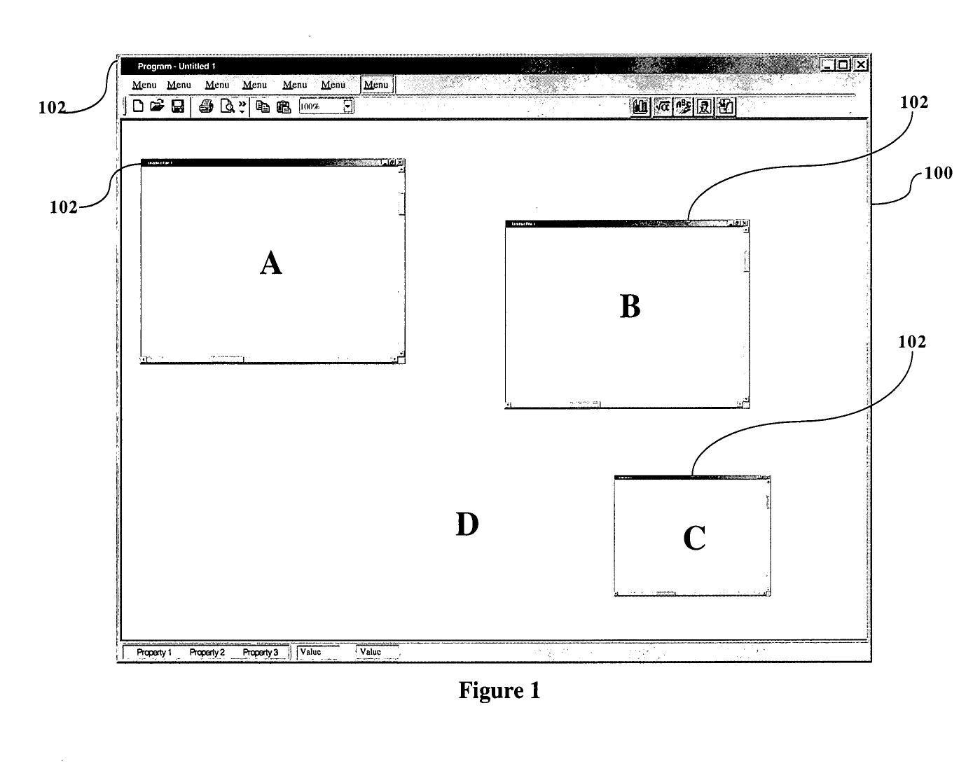

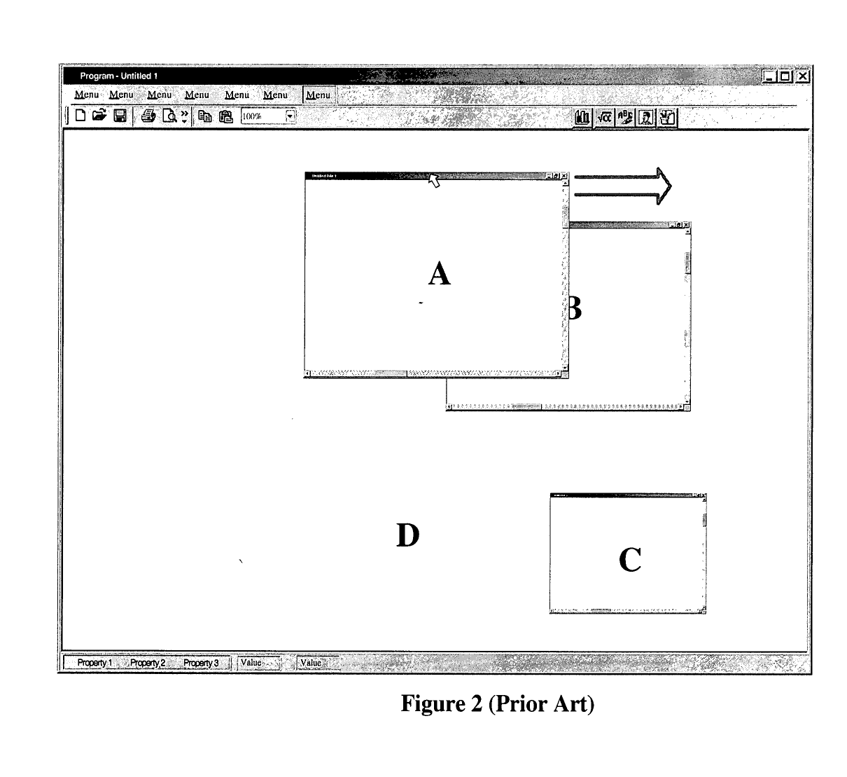

FIGS. 1 and 2 illustrate the operation, and deficiencies, of the prior art described above. FIG. 1 shows a typical desktop D, displayed within a GUI 100. Situated on the desktop are windows A, B, and C. Each window has a title bar 102 (as does desktop D), which is simply a graphical portion of the window where, typically, a title will be displayed, identifying the contents of the window.

The desktop D is a standard, overlapping desktop, where each window can overlap other windows. If a user wishes to move window A to the right, as shown in FIG. 2, the user “right-clicks” (using the right button of a mouse in a well-known manner) on the title bar 102 of window A and, while holding the mouse button down, moves the mouse to the right, thereby moving window A as well. As can be seen in FIG. 2, wherever window A and window B occupy the same space on the desktop, window A blocks the user's view of that portion of window B occupied by window A.

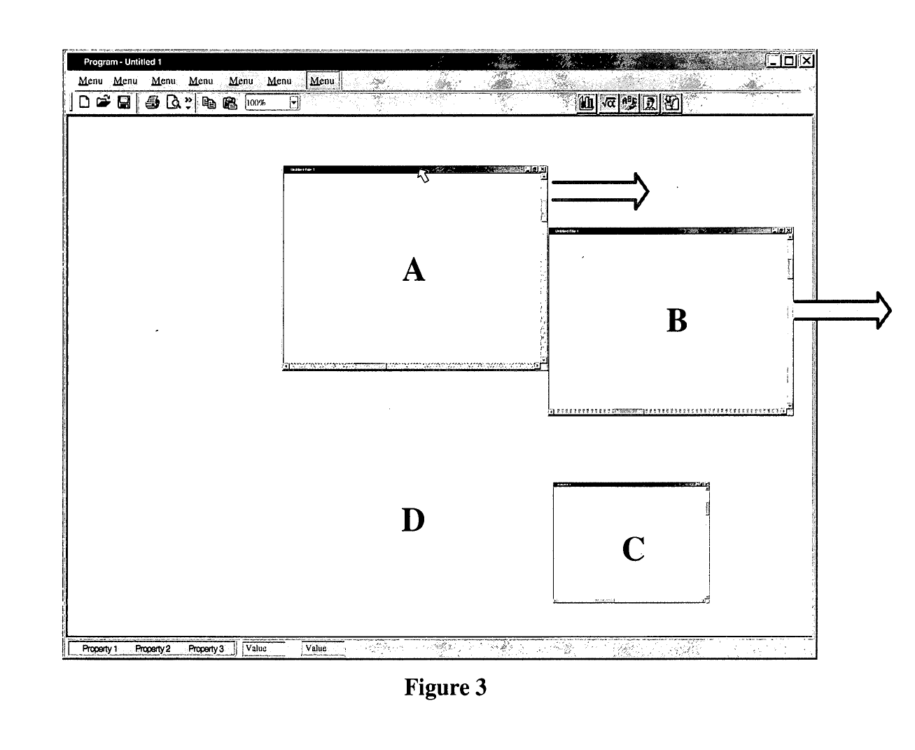

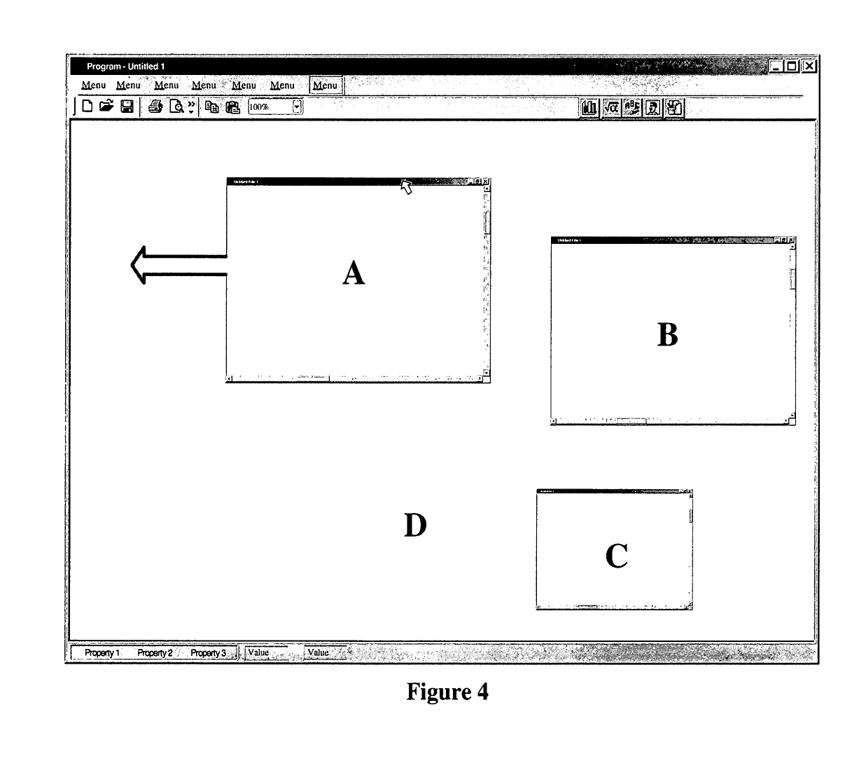

FIGS. 3 and 4 illustrate a first aspect of the present invention. The desktop D of FIGS. 3 and 4 are in a non-overlapping mode, where all windows occupy a single plane, in accordance with the present invention. Referring to FIG. 3, as a user moves window A to the right, at some point the right border of window A will touch the left border of window B. When this occurs, in accordance with a first embodiment of the present invention, window A pushes window B as window A is moved across the desktop. The behavior of the windows on the desktop of FIG. 3 is similar to the behavior of real objects on a real desktop. In other words, if there are two books placed on a desktop of an actual desk, and a user slides one book so that it pushes again the second book, the second book will slide in the direction of movement of the first book.

FIG. 4 illustrates what occurs when, in this embodiment, the user moves window A back to the left from the position to which it was pushed in FIG. 3. As can be seen, window B remains where it was pushed. Returning to the “real desk analogy” mentioned above, if the first book is moved back to the left after pushing the second book to the right, the second book will remain in place while the first book separates from the second book.

In the manner described above, a user can move windows around the desktop while keeping them in full view. This provides the user with the ability to situate windows in different locations while still having full access to the content displayed in the window.

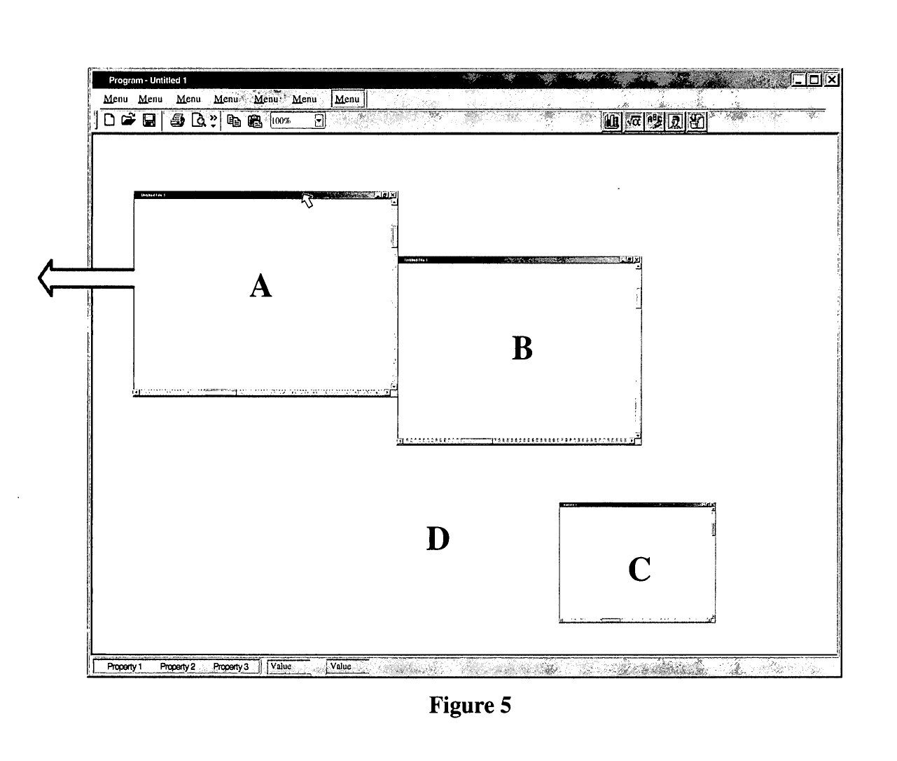

An alternative embodiment of the present invention is illustrated in FIG. 5. The different between the embodiment illustrated in FIG. 5 and the embodiment illustrated in FIG. 4 is that, in the embodiment of FIG. 5, a “sticky object” mode has been selected. (The actual selection of the sticky object mode can be done by a variety of methods, including by clicking on a button, selecting the option from a menu item, right-clicking on the GUI desktop, etc. The actual method of enabling or disabling this option is a design choice and is not considered critical to the present invention.) As illustrated in FIG. 5, in the sticky mode, when window A is moved to the left after having pushed window B to the right (e.g., as shown in FIG. 3), window B “sticks” to window A along the border where they initially made contact, i.e., window B is stuck to window A and moves wherever window A is moved to. This forms an object unit made up of the combined area of window A and window B. As an object unit, the two windows now move together as though they were one. Thus, no overlapping occurs and no resizing of the windows occurs.

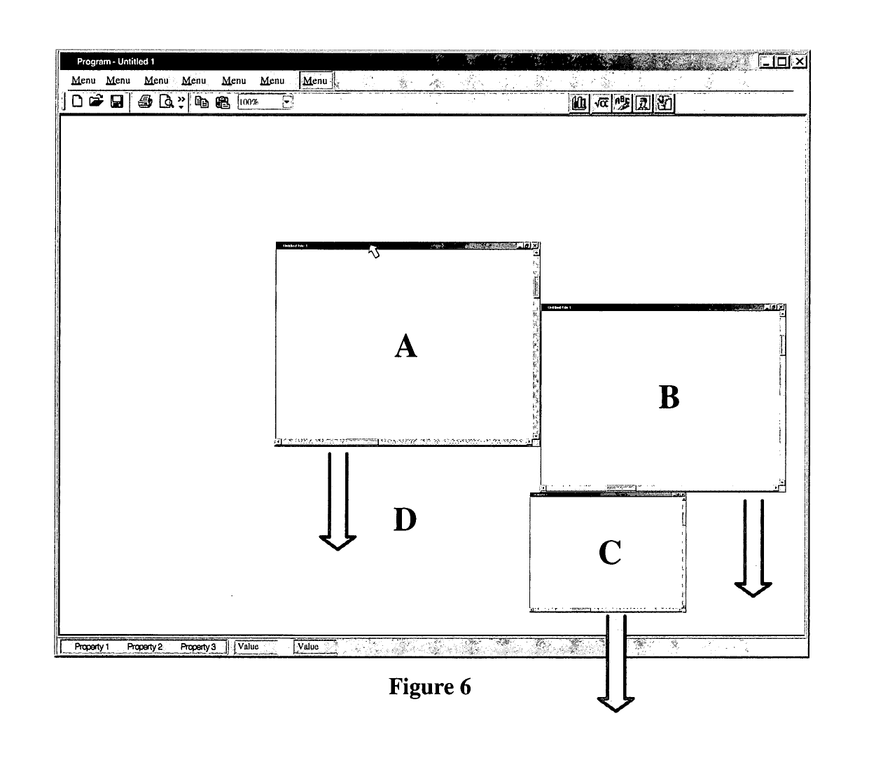

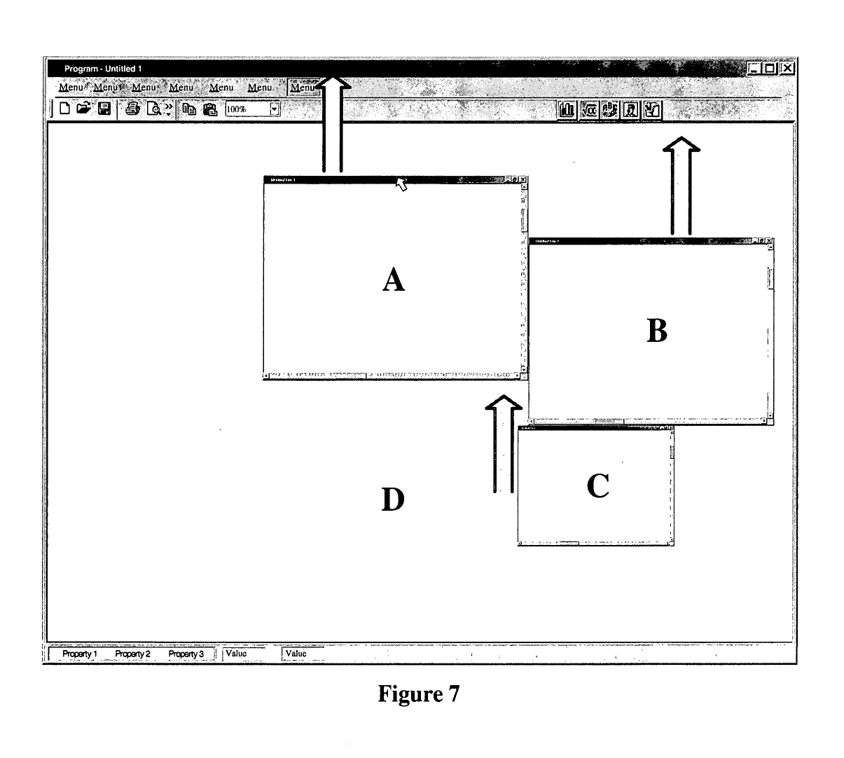

FIGS. 6 and 7 illustrate another aspect of the present invention. As seen in FIG. 6, when an object unit touches another window (or object) on the same desktop, and the desktop is in the sticky object mode, that window is “added” to the object unit. As can be seen, when an object unit comprising windows A and B is moved downward towards window C, window C sticks to the bottom edge of the object unit and is now joined thereto. As illustrated in FIG. 7, when the newly-formed object unit is moved upward, all three windows, including newly-added window C, move upward as a single group, i.e., as a new object unit comprising all three windows. If the desktop is not in sticky mode, then the downward movement illustrated in FIG. 5 will push window C to the bottom edge of the windowing unit, but when the window A/window B object unit is moved back upwards, window C will remain at the bottom edge of the desktop.

In a preferred embodiment, the GUI can be toggled between a standard overlap (normal) mode and the non-overlapping mode of the present invention. In standard overlap mode, the object being moved will always appear on top and overlap other objects when occupying the same work area space (as shown in FIG. 2). In non-overlapping mode, the desktop objects are “on top”, thus “colliding” with each other as they move (and coupling to each other when toggled into sticky mode, as described).

Activation of the various modes could be performed in numerous ways which will be apparent to those of ordinary skill in GUI programming. For example, the sticky mode can be activated by right clicking on the title bar of the GUI window and/or the window being moved, and deactivated by right clicking on the title bar a second time. Buttons to perform the toggling could be provided in a well-known manner, as could menu selections that would allow the toggling operation.

Another aspect of the present invention is the concept of management of objects that comprise an object unit. For example, if desired, membership in the object unit can be managed by selectively “ungluing” all borders, thereby detaching all windows in the set. Additionally, a “detach and auto-arrange” option can be implemented which allows the detachment of one window (e.g., detach a window to the right of the current border; detach a selected window, etc.) and rearrange the remaining windows in the object unit. Further, a “suspend” option could allow the current object unit to remain glued, but would prevent additional objects from being added to the set. This would comprise essentially the suspension of the “sticky state” so that the object unit, when moved, would merely push other objects out of the way rather than add them to the object unit.

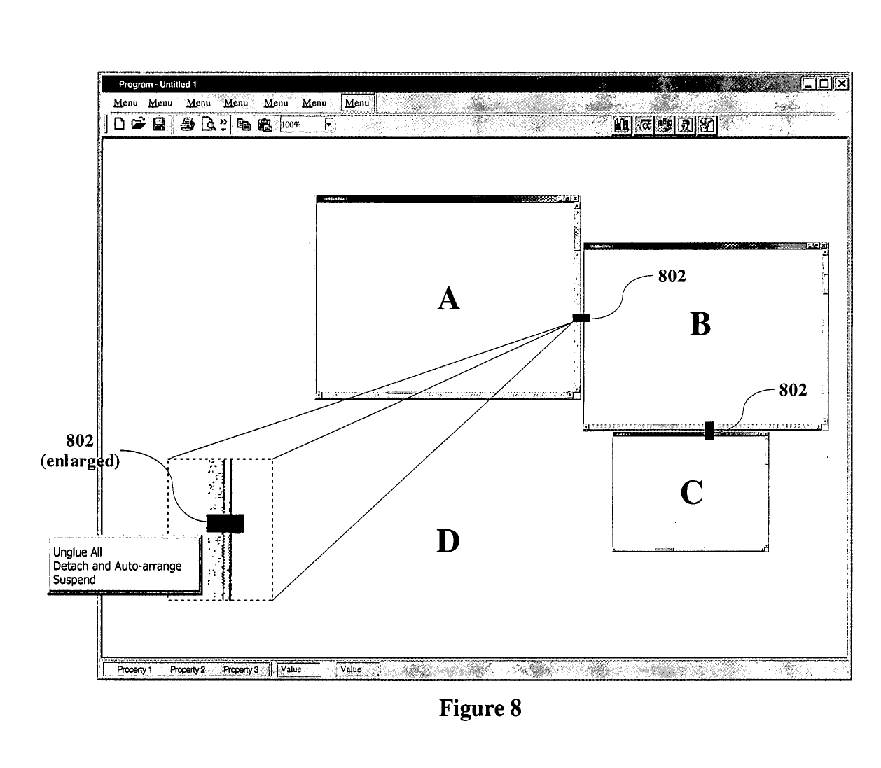

FIG. 8 illustrates an example of how the management option of the present invention could be implemented. As seen in FIG. 8, at a connection point between windows A and B, a management bar 802 is shown (another is shown at the connection point between window B and window C). By right-clicking on the management bar 802, a menu appears, giving the options “unglue all”; “detach and auto-arrange”; and “suspend”. By selecting the desired option, the associated function would be implemented as is well known. Obviously, many other methods of providing the management feature can be utilized, and numerous other management functions can also be implemented with respect to object units.

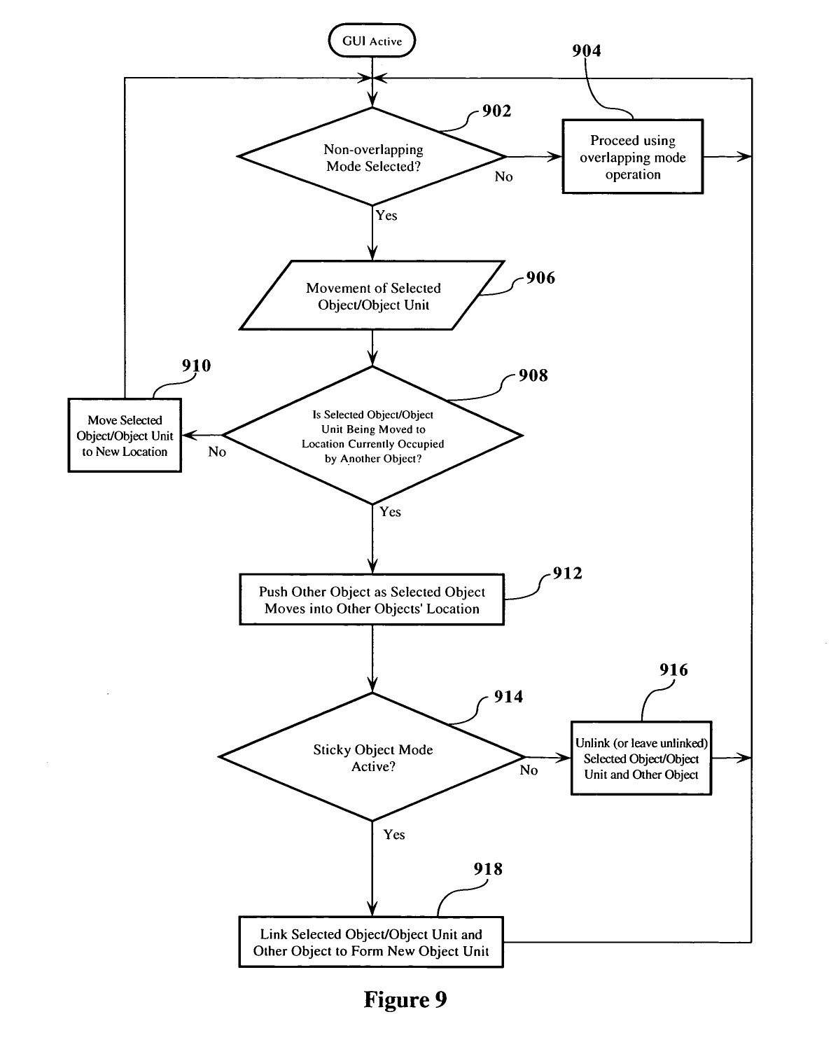

FIG. 9 illustrates an example of the logical steps of the present invention. The non-overlapping mode of the present invention is typically invoked by the user while using the GUI by making a menu selection, button selection, etc. as described above; however, it is understood that, if desired, the GUI can be actively in the non-overlapping mode by default, or permanently, depending upon the needs of the user.

At step 902, with the GUI active, a determination is made as to whether or not the non-overlapping mode has been selected. If the non-overlapping mode has not been selected, the process proceeds to step 904, and the overlapping mode of operation is utilized in a well-known manner. The process then reverts back to step 902 to continue to monitor whether or not the non-overlapping mode has been selected.

If the non-overlapping mode has been selected, the process proceeds to step 906. When movement of a selected object or object unit is detected, at step 908, a determination is made as to whether or not the selected object/object unit is being moved to a location currently occupied by another object. Making this determination is well within the skill of a programmer of ordinary skill and the details thereof are thus not further described herein.

If, at step 908, it is determined that the location to where the selected object/object unit is being moved is not occupied by another object, then at step 910, the selected object/object unit is moved to the new location, and the process proceeds back to step 902 for further monitoring of the mode of operation of the GUI. If, at step 908, it is determined that the selected object/object unit being moved is being moved to a location currently occupied by another object, then at step 912, in accordance with the present invention, the selected object/object unit being moved pushes the other object out of the way as the selected object/object unit is moved into the other object's current location. The programming required to enable the GUI to perform this action is well within the skill of an ordinary programmer and is not discussed further herein. Whenever the selected object is moved to the location of another object, it pushes that object out of the way and occupies the space from which the other object was pushed.

At step 914, a determination is made as to whether or not the sticky object mode is active. If the sticky object mode is not active, then the process proceeds to step 916, where the selected object/object unit and the other object pushed by the selected object/object unit is left unlinked (or, if it is already linked, is caused to become unlinked). The process then proceeds back to step 902 for further monitoring of the overlap/non-overlap mode.

If, at step 914, it is determined that the sticky object mode is active, then the process proceeds to step 918, and the selected object/object unit and the other object are linked to form a new object unit. For example, the selected object/object unit and other object can be linked using the management bars described above. The process then proceeds back to step 902 to monitor the overlap/non-overlap mode.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a computer running a GUI configured to include the present invention. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method for managing movement of objects within a workspace of a graphical user interface (GUI), comprising the steps of:
configuring said GUI into a non-overlapping workspace;
situating at least two of said objects in said non-overlapping workspace;
pushing a second of said objects in said non-overlapping workspace when a first of said objects comes in contact with said second of said objects while being moved.

2. The method of claim 1, wherein said movement of said first object such that it comes in contact with said second object displaces said second object without said first object overlapping said second object.

3. The method of claim 2, wherein said displacement of said second object by said first object causes and edge of said first object to abut an edge of said second object.

4. The method of claim 3, wherein upon said first object coming into contact with said second object, said abutting sides of said first and second objects become coupled to each other, forming an object unit.

5. The method of claim 4, wherein movement of said object unit such that it comes into contact with a third object causes said third object to become coupled to said object unit, thereby incorporating said third object into said object unit.

6. The method of claim 5, wherein movement of said object unit such that it comes onto contact with any other objects within said non-overlapping workspace causes each such object to become coupled to said object unit, thereby incorporating any such objects into said object unit.

7. The method of claim 6, further comprising the steps of:
configuring said object unit for management by providing controllable coupling and decoupling capability with respect to said objects forming and object unit.

8. The method of claim 1, wherein said GUI is switchable between said non-overlapping workspace configuration and an overlapping workspace configuration.

9. A system for managing movement of objects within a workspace of a graphical user interface (GUI), comprising:
means for configuring said GUI into a non-overlapping workspace;
means for situating at least two of said objects in said non-overlapping workspace; and
means for pushing a second of said objects in said non-overlapping workspace when a first of said objects comes in contact with said second of said objects while being moved.

10. The system of claim 9, wherein said movement of said first object such that it comes in contact with said second object displaces said second object without said first object overlapping said second object.

11. The system of claim 10, wherein said displacement of said second object by said first object causes and edge of said first object to abut an edge of said second object.

12. The system of claim 11, wherein upon said first object coming into contact with said second object, said abutting sides of said first and second objects become coupled to each other, forming an object unit.

13. The system of claim 12, wherein movement of said object unit such that it comes into contact with a third object causes said third object to become coupled to said object unit, thereby incorporating said third object into said object unit.

14. The system of claim 13, wherein movement of said object unit such that it comes onto contact with any other objects within said non-overlapping workspace causes each such object to become coupled to said object unit, thereby incorporating any such objects into said object unit.

15. The system of claim 14, further comprising:
means for configuring said object unit for management by providing controllable coupling and decoupling capability with respect to said objects forming and object unit.

16. The system of claim 9, wherein said GUI is switchable between said non-overlapping workspace configuration and an overlapping workspace configuration.

17. Computer readable code for managing movement of objects within a workspace of a graphical user interface (GUI), comprising:
first subprocesses for configuring said GUI into a non-overlapping workspace;
second subprocesses for situating at least two of said objects in said non-overlapping workspace; and
third subprocesses for pushing a second of said objects in said non-overlapping workspace when a first of said objects comes in contact with said second of said objects while being moved.

18. Computer readable code for managing movement of objects within a workspace of a graphical user interface (GUI) according to claim 17, further comprising:
fourth subprocesses for displacing said second object without said first object overlapping said second object when said first object is moved such that it comes in contact with said second object.

19. Computer readable code for managing movement of objects within a workspace of a graphical user interface (GUT) according to claim 18, further comprising:
fifth subprocesses for causing an edge of said first object to abut an edge of said second object when said first object displaces said second object.

20. Computer readable code for managing movement of objects within a workspace of a graphical user interface (GUI) according to claim 19, further comprising:
sixth subprocesses for coupling said abutting sides of said first and second objects to each other, forming an object unit, when said first object comes into contact with said second object.

21. Computer readable code for managing movement of objects within a workspace of a graphical user interface (GUI) according to claim 20, further comprising:
seventh subprocesses for coupling a third object to said object unit, thereby incorporating said third object into said object unit, when movement of said object unit causes it to come into contact with said third object.

22. Computer readable code for managing movement of objects within a workspace of a graphical user interface (GUI) according to claim 21, further comprising:
eighth subprocesses for causing any other objects to become coupled to said object unit, thereby incorporating each such object into said object unit, when movement of said object unit causes it to come into contact with any of said other objects within said non-overlapping workspace.

23. Computer readable code for managing movement of objects within a workspace of a graphical user interface (GUI) according to claim 22, further comprising:
ninth subprocesses for configuring said object unit for management by providing controllable coupling and decoupling capability with respect to said objects forming and object unit.

24. Computer readable code for managing movement of objects within a workspace of a graphical user interface (GUI) according to claim 17, wherein said GUI is switchable between said non-overlapping workspace configuration and an overlapping workspace configuration.
